(19) United States
(12) Patent Application Publication
(10) Pub. No.: US 2007/0013202 A1
(43) Pub. Date: Jan. 18, 2007

(54) Vehicle interior accessory having a pivotable door

(75) Inventor: Graham Tompson, Northville, MI (US)

Correspondence Address: QUINN LAW GROUP, PLLC, 39555 ORCHARD HILL PLACE, SUITE # 520, NOVI, MI, 48375, US

(73) Assignee: Sidler Inc., Madison Heights, MI (US)

(21) Appl. No.: 11/179,297

(22) Filed: Jul. 12, 2005

(51) Int. Cl. B60R 7/00

(52) U.S. Cl. 296/37.1

(57) ABSTRACT

A vehicle interior assembly includes a housing, a door pivotably mounted thereto, and a biasing member disposed therebetween. The housing has walls defining an interior and an opening. The walls include laterally opposed housing side walls and a connecting wall between the housing side walls, wherein the connecting wall has an inner surface. The door has a housing contact portion disposed on one side of the door for contact with the inner surface of the connecting wall of the housing at least when the door is latched to the housing in a closed rest position. The biasing member is disposed between the housing and the door on a side of the door opposite that of the housing contact portion of the door.

### TECHNICAL FIELD

The present invention generally relates to accessories for vehicle interiors, and more particularly relates to vehicle interior accessories having pivotable doors.

### BACKGROUND

Accessories for vehicle interiors often have pivotable doors and typically encompass a variety of stowable accessories such as cup-holders, ashtrays, garage door opener modules, sunglasses holders, mirrors, lights, or video monitors, and further encompass storage compartments such as glove compartments, armrest compartments, or overhead storage consoles. A stowable accessory or storage compartment usually includes a stationary housing having walls defining an interior volume and an opening area. Also, a pivotable door is typically mounted to the housing for pivoting movement between a closed position covering the opening area of the housing and an open position for exposing the interior volume of the housing or an inside portion of the pivotable door. Moreover, an opener spring is usually disposed between the housing and the door on one side of the accessory for biasing the pivotable door toward the open position.

Unfortunately, however, the housing and pivotable door are typically composed of plastic and may be particularly prone to softening and deformation in the presence of high temperature conditions in the interior of the vehicle, such as during a hot summer day in the desert with no ventilation. Moreover, many accessories use a single opener spring on only one side of the pivotable door, wherein the single spring imposes an off-center or unbalanced force on the door. The combination of the summer heat acting to soften the housing and the door, and the unbalanced opening force imposed by the single spring, tends to cause the door to become cocked within the housing, thereby detracting from a desired finished appearance within the vehicle interior.

Typical solutions to the problem involve adding extra components to stabilize the door within the housing. But adding extra components increases component manufacturing complexity and costs, increases assembly complexity and costs, adds potential product failure modes, and ultimately unnecessarily increases overall product costs to consumers.

### SUMMARY

A presently preferred embodiment of a vehicle interior assembly includes a housing, a door pivotably mounted thereto, and a biasing member disposed therebetween. The housing has walls defining an interior and an opening. The walls include laterally opposed housing side walls and a connecting wall between the housing side walls, wherein the connecting wall has an inner surface. Also, the door has a housing contact portion disposed on one side of the door for contact with the inner surface of the connecting wall of the housing, such as when the door is latched to the housing in a closed rest position. Moreover, the biasing member is disposed between the housing and the door on a side of the door opposite that of the housing contact portion of the door.

### BRIEF DESCRIPTION OF THE DRAWINGS

Features and advantages of the present invention will be apparent to those of ordinary skill in the art from the following detailed description of preferred exemplary embodiments and best mode of the invention and the claims, with reference to the accompanying drawings in which:

FIG. 1 is a perspective view of a portion of a passenger compartment in a vehicle having a presently preferred embodiment of an accessory assembly with a pivotable door shown in a closed rest position;

FIG. 2 is an enlarged perspective view of the accessory assembly of FIG. 1, illustrating the pivotable door in an open position;

FIG. 3 is a cross-sectional view of the accessory assembly of FIG. 1, taken along line 3-3 thereof;

FIG. 4 is a partially broken-out side view of the accessory assembly of FIG. 2, viewed in the direction of arrow 4 thereof;

FIG. 5 illustrates the accessory assembly of FIG. 4, with the pivotable door pivoted to a position of initial contact with a latch;

FIG. 6 illustrates the accessory assembly of FIG. 5, with the pivotable door pivoted to a bottomed out position;

FIG. 7 illustrates the accessory assembly of FIG. 6, with the pivotable door in a closed rest position, wherein the door is latched and substantially flush with respect to the housing;

FIG. 8 illustrates a prior art accessory assembly, illustrating a pivotable door in a closed position but softened and distorted; and

FIG. 9 is a partially broken-out side view of the prior art accessory assembly of FIG. 8, viewed in the direction of arrow 9 thereof.

### DETAILED DESCRIPTION

Overview

In general, one example of the invention will be described in an embodiment of an accessory assembly having a pivotable door for use in a passenger compartment of a vehicle. The exemplary embodiment will be described with reference to its use in automotive vehicles such as cars, trucks, sport-utility vehicles, and the like. However, it will be appreciated as the description proceeds that the invention is useful in many different applications such as recreational vehicles, aircraft, watercraft, and the like, and may be implemented in many other embodiments. In this regard, and as used herein and in the claims, it will be understood that the term “vehicle” refers not only to automotive applications, but also to any other applications wherein the present invention is useful in passenger compartments thereof. Structure

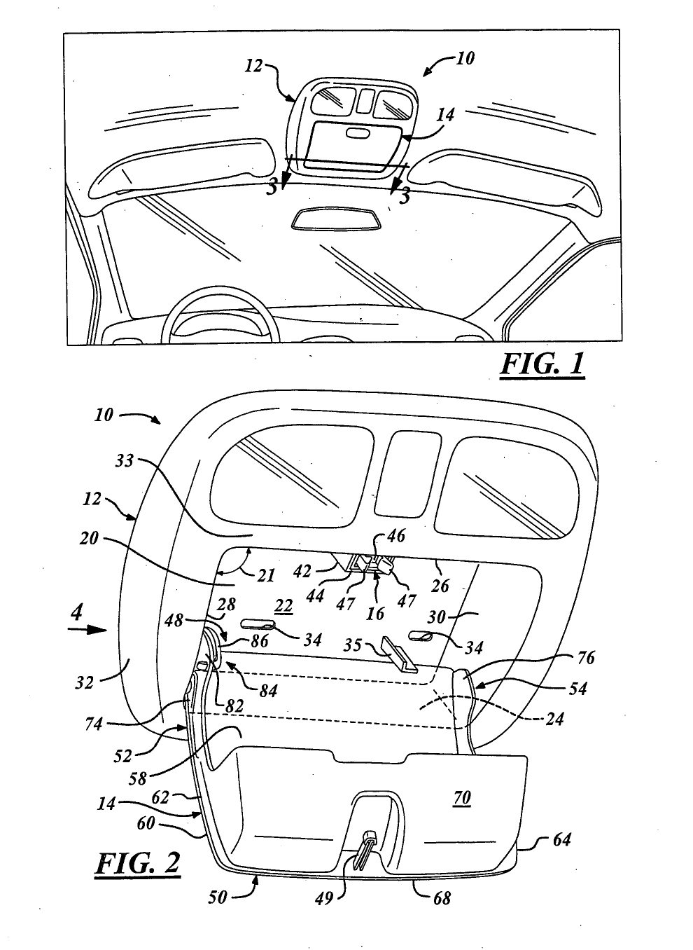

Referring to the drawings, an accessory assembly having a pivotable door 14 is generally shown at 10 in FIG. 1. The assembly 10 is preferably adapted for installation in a vehicle and used for storage of items in a vehicle interior. Other types of assemblies, besides storage assemblies, are also contemplated including coin bins, ashtrays, cup holders, garage door opener modules, sunglasses holders, mirrors, lights, video monitors, glove compartments, armrest compartments, overhead storage consoles, or any other type of assembly used in a vehicle where a pivotable door 14 is desired. The assembly 10 comprises the pivotable door 14, which is pivotably mounted to a stationary housing 12. The housing 12 is preferably a storage compartment, but may be any suitable housing component for storing items or for stowing apparatus carried by or connected to the door 14. The door 14 is pivotably hinged to the housing 12 and acts as a cover to secure items within the housing 12 and/or conceal apparatus therein.

As shown in FIG. 2, the pivotable door 14 may be latched to the housing 12 by a latching mechanism 16 mounted to the housing 12 of the assembly 10. Accordingly, the latching mechanism 16 is used for securing the door 14 to the housing 12 when the assembly 10 is closed. It is contemplated, however, that the latching mechanism 16 could instead be adapted for mounting to the door 14, involving a mere reversal of parts that would fall within the broad scope and spirit of the claims.

The housing 12 is preferably a storage compartment but may be a frame, platform, bezel, headliner, or other structural support member for use with a glove box, coin bin, storage compartment, ashtray, cup holder, video monitor, or the like for the interior of the vehicle. The housing 12 is typically constructed of plastic, but other materials suitable for construction such as metal, wood, composites, and the like may be used. Preferably, the housing 12 is injection molded from acrylonitrile-butadiene-styrene (ABS) resin. The housing 12 may be used in a vehicle dashboard, door, armrest, center console, headliner or any other area where storage of items or stowage of apparatus is desired in the interior of the vehicle.

The housing 12 shown in FIG. 2 contains a base 20 and at least four walls that define an opening area 21 and an interior volume or open section 22. The walls include a first connecting wall or front wall 24, a second connecting wall or rear wall 26, a first side wall 28, and a second side wall 30. Preferably, the housing 12 has a skirt 32 that extends out from at least the front wall 24 and that provides a decorative margin that allows the housing 12 to easily install into the vehicle interior. The housing 12 also includes an outer surface 33 that presents a “class A” surface in the interior of the vehicle passenger compartment. Additionally, the base 20 of the housing 12 may contain bolt holes 34 therethrough to allow the assembly 10 to be bolted to the vehicle, such as in the dashboard, instrument panel, headliner or the like. The base 20 may also include a door stop 35 projecting in a direction generally normal with respect to the plane generally defined by the base 20.

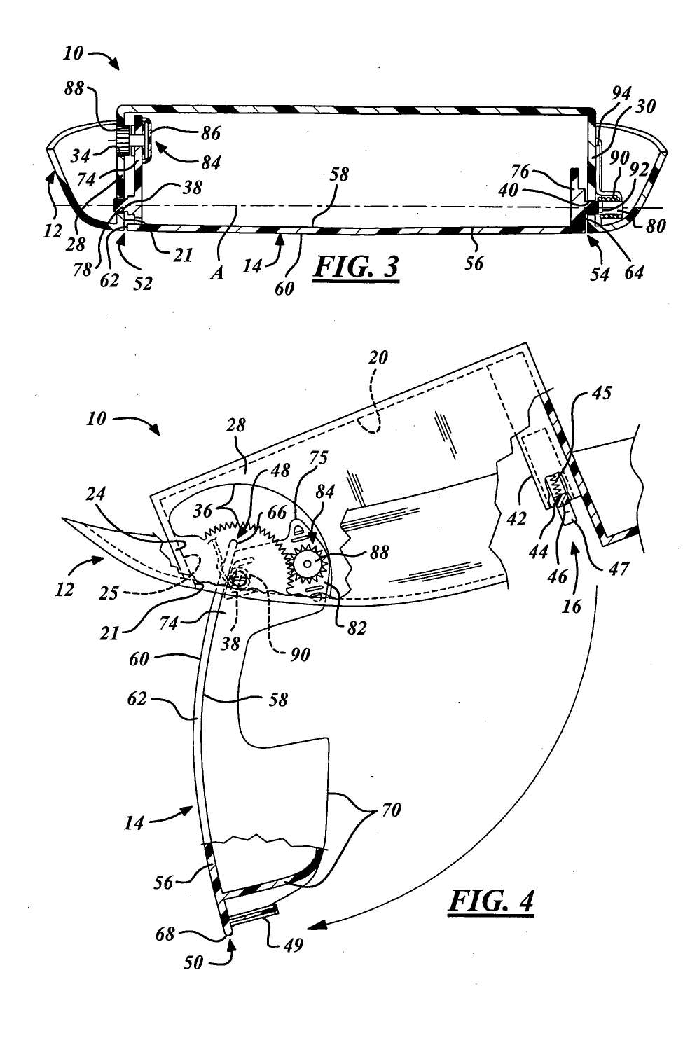

As shown in FIGS. 3 and 4, the first side wall 28 may include an arcuate, toothed aperture 36 for cooperating with the door 14 as will be described in detail herein below. The housing 12 also contains hinge or pivot holes 38, 40 through the side walls 28, 30 to allow the door 14 to act as a lid or cover in the open area over the open section 22 of the housing 12, as will be described in detail herein below.

Referring to FIGS. 2 and 4, the latching mechanism 16 may be any suitable device for holding the door 14 in position with respect to the housing 12 but is preferably a push-push latch mounted to a support column 42 of the housing 12 in a location laterally centered across the housing opening, relatively proximate the rear wall and distal the front wall. Those of ordinary skill in the art will recognize that the push-push latch may be any suitable push-push latch, not only the one shown here. In any case, the latching mechanism 16 may have a stationary outer body 44, which is press and snap fit into an aperture of the support column 42 of the housing, and a movable inner member 46 translatably mounted and retained within the outer body 44 with a spring 45 and push-push pawl and detent features (not shown) therebetween. The movable inner member 46 includes flexible barbed clasps 47 that positively interengage with a latching element or barbed bayonet 49 of the door 14 when the inner member 46 is locked within the outer body 44, as will be described in further detail below.

Referring to FIG. 3, the door 14 is pivotably mounted to the housing 12 about a pivot axis A so as to serve as a movable closure for the assembly 10. The door 14 is preferably a single integral component composed of plastic but may constructed of two or more different components. For example, like the housing 12, the door 14 may be injection molded from ABS, or may be injection molded from a polycarbonate/ABS blend material for improved resistance to warpage or deformation. The door 14 is preferably slightly smaller in area than the area of the opening area 21 of the housing 12 with a slight circumferential gap therebetween. Accordingly, the door 14 is preferably fit flush with the housing 12.

Referring to FIGS. 2 through 4, the door 14 includes a hinge end 48, a latch end 50 disposed oppositely of the hinge end 48, and oppositely disposed first and second sides 52, 54. The door 14 further includes a cover 56 having oppositely disposed inner and outer surfaces 58, 60 wherein the outer surface 60 may be an automotive “class A” surface adapted for contact with a passenger's hand in the passenger compartment of the vehicle. The cover 56 may also have oppositely disposed first and second side edges 62, 64, and a hinge edge 66 and an oppositely disposed latch edge 68.

The door 14 also includes a sunglasses pocket 70 and the latching element 49 carried by the inner surface 58 of the cover at the latch end 50, proximate the latch edge 68 and distal the hinge edge 66. The latching element 49 is preferably a barbed bayonet as shown and, as discussed above, it is contemplated that the latching mechanism or push-push latch 16 could instead be adapted for mounting to the door 14 and the bayonet 72 could be adapted for mounting to the housing 12, involving a mere reversal of parts that would fall within the broad scope and spirit of the claims. Instead of or in addition to the sunglasses pocket 70, it is contemplated that the door 14 may carry any other suitable structure or apparatus such as a cup holder, garage door opener holder, video monitor, or the like. The door 14 additionally includes first and second door side walls 74, 76 carried by the inner surface 58 of the cover 56 at the oppositely disposed sides 52, 54 of the door 14.

As shown in FIG. 4, the first door side wall 74 has a housing contact portion 75 disposed on one side of the door 14 for contact with an inner surface 25 of the front wall 24 of the housing 12 when the door 14 is in a closed rest position with respect to the housing 12. The housing contact portion 75 may be a surface, edge, or the like disposed generally at a front side of the door 14.

Referring to FIG. 3, the pivot axis A is at least partially defined by first and second pivot elements 78, 80 laterally extending in an outboard direction away from the door side walls 74, 76 through the housing side walls 28, 30 and being supported or carried by the respective door side walls 74, 76. In another implementation, it is contemplated that the pivot elements 78, 80 could instead be integral with and carried by the side edges 62, 64 of the cover 56. In any case, the pivot elements 78, 80 may be hinge pins, axles, projections, or the like, that extend from the sides 52, 54 of the door 14. Those of ordinary skill in the art will recognize that any suitable pivoting means may be provided between, or integral with, the door 14 and the housing 12 to enable the door 14 to be pivoted with respect thereto.

Referring to FIGS. 2 through 4, the first door side wall 74 includes an extension 82 disposed on an opposite side of the first hinge pin 78 relative to the cover 56 and is adapted for carrying a dampener 84 and for contacting the front wall 24 of the housing 12 by way of the housing contact portion or front edge 75. The dampener 84 includes a top portion 86 secured to the extension and a toothed member 88, or gear, rotatably attached to the top portion 86. The toothed member 88 suitably engages the arcuate toothed aperture 34 of the first side wall 28 of the housing 12 as the door 14 is pivoted. In one alternative arrangement, the dampener 84 could instead be fixably mounted to the first side wall 28 of the housing 12 and the door extension 82 could have teeth for engaging the toothed member 88 of the dampener 84, involving a mere reversal of parts that would fall within the broad scope and spirit of the claims. As known in the art, the dampener 84 may contain a viscous fluid for retarding rotation of the toothed member 88 in relation to the top portion 86. Accordingly, the dampener 84 retards motion of the door 14 when it opens when it is pushed closed by a user. The extension 82 of the first door side wall 74 includes the front edge 75 that is adapted for contacting the inner surface 25 of the front wall 24 of the housing 12 particularly when the door 14 is being latched to the housing 12 and when the door 14 is in its closed rest position.

Finally, a biasing member 90 is disposed between the housing 12 and the door 14 on a side of the door 14 opposite that of the front edge 75 of the door 14, to bias the door 14 toward its open position, thereby enabling the door 14 to move to its open position once the door 14 is unlatched from the housing 12. The biasing member 90 may be any suitable device in any suitable location between the door 14 and the housing 12. Preferably, however, the biasing member 90 is a torsional spring coiled about the second hinge pin 80 of the door 12 and having one end 92 engaged to the hinge pin 80 through an axial slot thereof and an opposite end 94 engaged against a portion of the housing 14, as shown in FIG. 3. The biasing member or coiled torsional spring 90 is thus disposed between the housing 12 and the door 14 on the second side 54 of the door 14 opposite that of the first side 52. Accordingly, under its stored energy in its closed position, the spring 90 tends to unwind and thereby rotate the hinge pin 80 to bias or pivot the door 14 toward its open position. Operation

In general, and referring to FIG. 4, to facilitate easy opening of the stowable accessory assembly 10, the push-push latch 16, coiled torsional spring 90, and viscous damper 84 are deployed between the housing 12 and the pivotable door 14. The push-push latch 16 allows a user to open or close the pivotable door 14 without the use of a handle or button. For example, when the door 14 is open, the vehicle passenger simply pushes the door 14 towards the housing 12 to allow the latch 16 to lock and hold the door 14 closed. When the pivotable door 14 is in a latched position, the passenger merely pushes the door 14 in a direction further toward the housing 12, preferably bottoming out the door 14 against the housing 12, and then releases the door 14 to allow the door 14 to open out and away from the housing 12 under the torsional bias force of the spring 90 and under the predetermined rate of opening of the viscous damper 84.

More specifically, and referring to FIGS. 2 and 4, the assembly 10 operates in the following fashion. With the assembly 10 open the door 14 is biased to its open position by the biasing member 90 and the hinge edge 76 of the door 14 rests against the door stop 35 to prevent the door 14 from opening beyond a predetermined desired amount such as to avoid a pinch condition between the outer surface 60 of the cover 56 and the opening area 21 of the housing 12. As the door 14 is closed by the vehicle passenger, the door pivots about the pivot axis A defined by the hinge pins 78, 80 and/or hinge pin holes 38, 40 such that the toothed gear 88 of the dampener 84 rotatably engages the toothed arcuate aperture 34 of the housing 12 and such that the coiled torsional spring 90 is wound or loaded.

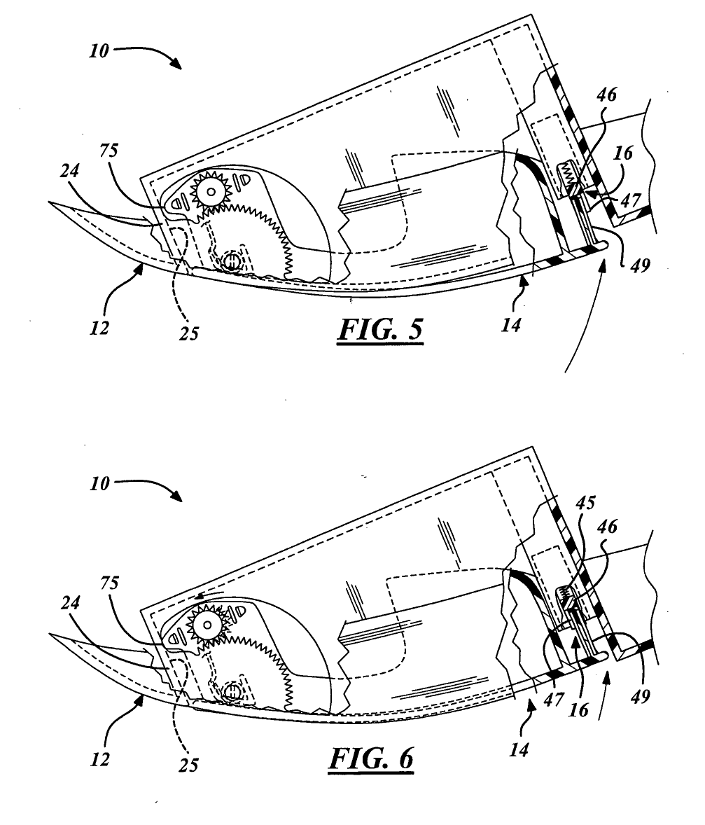

As shown in FIG. 5, as the door 14 is further pushed closed, the free end of the bayonet 49 eventually makes initial contact with the movable inner member 46 of the push-push latch 16, preferably slightly before the front edge 75 of the first side wall 74 of the door 14 makes contact with the inner surface 25 of the front wall 24 of the housing 12.

Referring to FIG. 6, as the door 14 is pushed closed even further toward the housing 12 to latch the door 14 thereto, the bayonet 49 begins to displace the movable inner member 46 against a bias force of the internal spring 45 therein, and the front edge 75 of the first side wall of the door initially contacts the inner surface 25 of the front wall 24 of the housing 12. From this point in the latching sequence, and until the door 14 is thereafter unlatched, the front edge 75 of the door 14 remains in contact with the inner surface 25 of the front wall 24 of the housing 12, thereby placing a compressive or bending load on the door 14. The door 14 may be further pushed closed toward the housing 12, placing further load on the door 14, until the bayonet 49 has displaced the push-push latch 16 to such an extent that it clicks into a detent condition just before the bayonet 49 bottoms out in a fully pushed closed position of the door 14. Accordingly, the clasps 47 of the inner member 46 of the push-push latch 16 lock on the free end of the bayonet 49 to couple the door 14 to the housing 12.

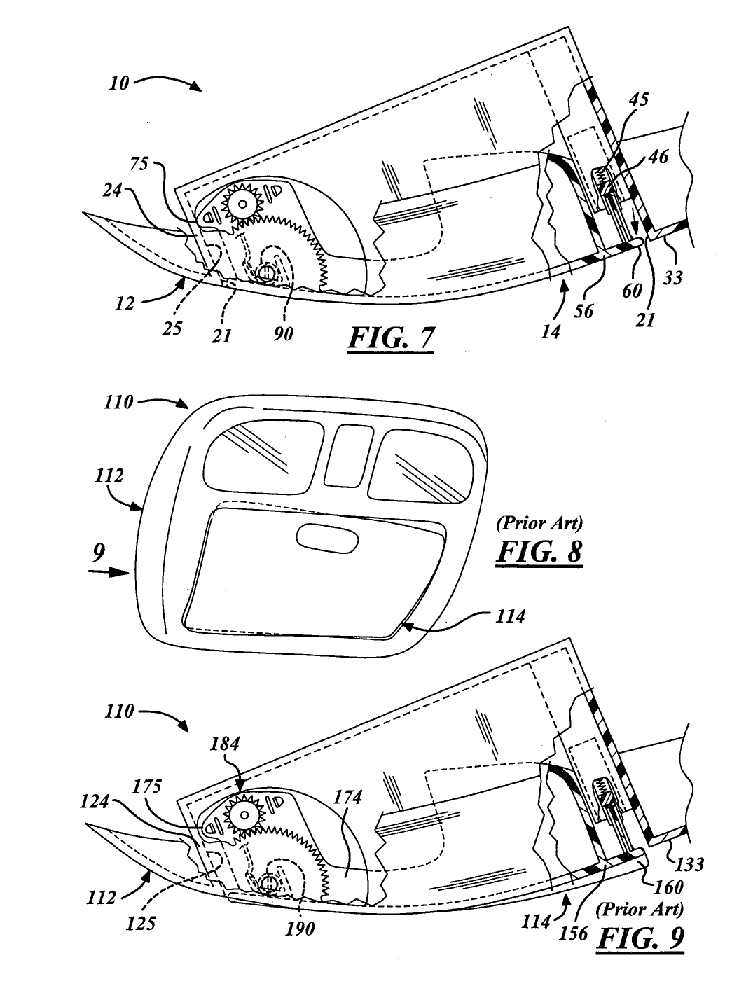

Referring to FIG. 7, as the door 14 is released from its fully pushed closed position to its closed rest position, as shown, the front edge 75 of the door 14 remains in contact with the inner surface 25 of the front wall 24 of the housing 12. In this position, the door 14 remains loaded and the outer surface 60 of the door cover 56 is substantially flush with the outer surface 33 of the housing 12 around the opening area 21. Accordingly, the door 14 is in a loaded or pre-loaded state such that the door 14 is under compressive or bending stress between the push-push latch 16 and the contact area between the front edge 75 of the door 14 and the inner surface 25 of the front wall 24 of the housing 12.

The assembly 10 is thus designed such that the front edge 75 of the door 14 remains in contact with the inner surface 25 of the front wall 24 of the housing 12 during high-heat conditions within the passenger compartment of the vehicle. Accordingly, such contact enables the door 14 to remain in its stressed or pre-loaded condition to resist deformation of the door 14 due to softening of the door or housing material and due to the off-center bias force imposed by the spring 90. In other words, the pre-loaded condition of the door 14 provides a reaction force to oppose or counteract the force imposed by the spring 90 and, thus, stabilize the geometry of the door 14 regardless of high temperature conditions in the passenger compartment of the vehicle.

To release the door 14 from its closed rest position shown in FIG. 7, the passenger merely pushes the door 14 back towards the housing 12 against the bias force of the torsional spring 90, the bias force of the internal spring 45 in the push-push latch 16, and the inherent resistance of the already stressed door 14. As the door 14 is pushed from its latched-closed rest position towards the housing 12 so that the bayonet 49 eventually bottoms out again within the push-push latch 16, the bayonet 49 displaces the movable inner member 46 until the push-push latch 16 clicks out of detent and unlocks to enable release the bayonet 49. When the passenger releases the door 14, the combined forces imposed by the torsional spring 90, the internal spring 45 in the push-push latch 16, and the pre-loaded door 14 act to pivot the door 14 away from the housing 12 to its fully open position. In this exemplary embodiment, the force of gravity also acts to pivot the door 14 to its fully open position.

Conclusion

Advantageously, the door 14 of the accessory assembly 10 tends not to become cocked with respect to the housing 12 in response to high temperature conditions within the vehicle, unlike many accessory assemblies of the prior art. For example, prior art FIGS. 8 and 9 illustrate a heat-affected accessory assembly 110 including a housing 112, a door 114 pivotably mounted thereto, a dampener 184 mounted at one side of the assembly 110 to a side wall 174 of the door 114 and disposed between the door 114 and the housing 112, and a coiled torsional spring 190 mounted at an opposite side of the assembly 110 between the door 114 and the housing 112.

Under high temperature conditions within a vehicle, the plastic materials of the assembly 110 soften and become rubbery, and the stored energy of the single torsional spring 190 cocks or raises the side of the door 114 that the spring 190 is disposed on, thereby causing an opposite side of the door 114 to cock or lower, as best shown in FIG. 8. As shown in FIG. 9, there is a gap or clearance between a front edge 175 of the door 114 and an inside surface 125 of a front wall 124 of the housing 114, such that nothing prevents the door 14 from being distorted by an unbalanced force from the off-center spring 190 when the assembly materials are softened by high temperature conditions within the passenger compartment of the vehicle. The result is a typical accessory assembly 110 having the door 114 that is cocked or warped with respect to its housing 112, thereby giving a distorted appearance to the door 114. In other words, the door 114 is not substantially flush with the housing 112. Or more particularly, a class A outer surface 160 of the door 114 is not substantially flush with a class A outer surface 133 of the housing 112.

In contrast, the accessory assembly 10 described herein provides a means for stabilizing the door 14 within the housing 12 so as to resist or prevent distortion and cocking of the door 14 therein. In particular, the extension 82 of the side wall 74 of the door 14 is purposely extended in length compared to prior art side walls, thereby enabling the front edge 75 of the door 14 to be in contact with the housing 12 especially when the door 14 is in its latched-closed rest position. The contact between the front edge 75 of the door 14 and the front wall 24 of the housing 12 when the assembly is latched acts to pre-load the door 14 and thereby resist deformation of the door 14 in the presence of high temperature conditions under the bias force of the single spring 90. Accordingly, the accessory assembly 10 presents a solution to the door deformation problem that is far more cost-effective than previous approaches.

As used in the sections above and claims below, the terms “for example,” “for instance,” and “such as,” and the verbs “comprising,” “having,” “including,” and their other verb forms, when used in conjunction with a listing of one or more components or other items, are each to be construed as open-ended, meaning that that the listing is not to be considered as excluding other, additional components, elements, or items. Moreover, directional words such as front, rear, top, bottom, upper, lower, radial, circumferential, axial, lateral, longitudinal, vertical, horizontal, transverse, and the like are employed by way of description and not limitation. Other terms are to be construed using their broadest reasonable meaning unless they are used in a context that requires a different interpretation. When introducing elements of the present invention or the embodiments thereof, the articles “a,” “an,” “the,” and “said” are intended to mean that there are one or more of the elements.

It is to be understood that the invention is not limited to the particular exemplary embodiment disclosed herein, but rather is defined by the claims below. In other words, the statements contained in the foregoing description relate to a particular exemplary embodiment and are not to be construed as limitations on the scope of the invention as claimed below or on the definition of terms used in the claims, except where a term or phrase is expressly defined above. And although the present invention has been disclosed in conjunction with a single presently preferred exemplar embodiment, many other embodiments are possible and it is not intended herein to mention all of the possible equivalent forms and ramifications of the present invention. Other modifications, variations, forms, ramifications, substitutions, and/or equivalents will become apparent or readily suggest themselves to persons of ordinary skill in the art in view of the foregoing description.

In other words, the present invention encompasses many reasonable substitutions or equivalents of limitations recited in the following claims. As just one example, the disclosed structure, materials, sizes, shapes, and the like could be readily modified or substituted with other similar structure, materials, sizes, shapes, and the like. In another example, the invention has been disclosed in conjunction with a storage compartment. However, additional applications are contemplated for the invention, such as stowable accessory assemblies such as video monitors, or any other applications where it is desirable to maintain a finished flush appearance of a door of an accessory assembly, and can be provided without departing from the disclosure herein. Indeed, the present invention is intended to embrace all such forms, ramifications, modifications, variations, substitutions, and/or equivalents as fall within the spirit and broad scope of the following claims.

1. A vehicle interior assembly comprising:
a housing having walls defining an interior and an opening, the walls including laterally opposed housing side walls and a connecting wall between the housing side walls, the connecting wall having an inner surface;
a door pivotably mounted to the housing and having a housing contact portion disposed on one side of the door for contact with the inner surface of the connecting wall of the housing at least when the door is latched to the housing in a closed rest position; and
a biasing member disposed between the housing and the door on a side of the door opposite that of the housing contact portion of the door.

2. The vehicle interior assembly of claim 1, wherein said door has a cover with an outside surface and an inside surface, and has door side walls extending from the inside surface of the cover, further wherein said housing contact portion is a front edge of one of said door side walls.

3. The vehicle interior assembly of claim 1, wherein said assembly is a storage compartment assembly such as a sunglasses storage module, or the like.

4. The vehicle interior assembly of claim 1, wherein the housing and the door are composed of plastic.

5. The vehicle interior assembly of claim 4, wherein the housing is composed of ABS and the door is composed of PC/ABS.

6. The vehicle interior assembly of claim 1, wherein the biasing member is a coiled torsional spring.

7. The vehicle interior assembly of claim 1, further comprising:
a latching mechanism mounted to the housing in a location laterally centered across the housing opening relatively distal the connecting wall.

8. The vehicle interior assembly of claim 7, wherein said latching mechanism is a push-push latch.

9. The vehicle interior assembly of claim 1, further comprising:
a dampener disposed between the housing and the door.

10. A vehicle interior assembly comprising:
a housing having walls defining an interior and an opening, the walls including laterally opposed housing side walls, a front wall between the housing side walls, and a rear wall between the housing side walls opposite of the front wall;
a door pivotably mounted to the housing about a pivot axis, the door including a cover having an outside surface and an inside surface, a latching element extending from the inside surface of the cover, door side walls extending from the inside surface of the cover, and hinge pins laterally extending in an outboard direction away from the door side walls and through the housing side walls to define a door pivot axis, wherein one of the door side walls has a front portion adapted for contact with the front wall of the housing;
a latching mechanism mounted to the housing in a location laterally centered across the housing opening relatively proximate the rear wall and relatively distal the front wall; and
a torsional spring coiled about one of the hinge pins of the door having one end engaged to the one of the hinge pins and an opposite end engaged against the housing, the torsional spring being disposed between the housing and the door on one side of the door opposite that of the door side wall having the front portion adapted for contact with the front wall of the housing.

11. The vehicle interior assembly of claim 10, wherein said assembly is a storage compartment assembly such as a sunglasses storage module, or the like.

12. The vehicle interior assembly of claim 10, wherein the housing and the door are composed of plastic.

13. The vehicle interior assembly of claim 12, wherein the housing is composed of ABS and the door is composed of PC/ABS.

14. The vehicle interior assembly of claim 10, wherein the latching mechanism is a push-push latch.

15. The vehicle interior assembly of claim 10, further comprising:
a dampener disposed between the housing and the door.

16. A vehicle interior assembly comprising:
a housing having walls defining an interior and an opening, the walls including laterally opposed housing side walls, a front wall between the housing side walls, and a rear wall between the housing side walls opposite of the front wall;
a door pivotably mounted to the housing about a pivot axis, the door including:
a hinge end;
a latch end disposed oppositely of the latch end;
oppositely disposed sides;
a cover having oppositely disposed inner and outer surfaces, oppositely disposed side edges, and a hinge edge and an oppositely disposed latch edge;
a latching element carried by the inner surface of the cover at the latch end, proximate the latch edge and distal the hinge edge;
door side walls carried by the inner surface of the cover at the oppositely disposed sides wherein a reaction one of the door side walls has a front portion adapted for contact with the front wall of the housing when the door is in a closed latched position with respect to the housing; and
a pivot axis defined by hinge pins laterally extending in an outboard direction away from the side walls through the housing side walls and being carried by at least one of the cover or the door side walls;
a push-push latch mounted to the housing in a location laterally centered across the housing opening relatively proximate the rear wall and distal the front wall; and
a torsional spring coiled about one of the hinge pins of the door having one end engaged to the one of the hinge pins and an opposite end engaged against a portion of the housing, the torsional spring being disposed between the housing and the door on one side of the door opposite that of the reaction door side wall.

17. The vehicle interior assembly of claim 16, wherein said assembly is a storage compartment assembly such as a sunglasses storage module, or the like.

18. The vehicle interior assembly of claim 16, wherein the housing and the door are composed of plastic.

19. The vehicle interior assembly of claim 18, wherein the housing is composed of ABS and the door is composed of PC/ABS.

20. The vehicle interior assembly of claim 16, further comprising:
a dampener disposed between the housing and the door.
